(19) United States
(12) Patent Application Publication
(10) Pub. No.: US 2009/0115231 A1
(43) Pub. Date: May 7, 2009

(54) ADJUSTABLE BACKREST ASSEMBLY FOR A MOTORCYCLE

(75) Inventors: Benjamin Phillip Davis, Brookfield, WI (US); Jeremy Nesthus, Waukesha, WI (US); Matthew J. Van Dyke, West Allis, WI (US); Jeffrey T. Pagel, South Milwaukee, WI (US)

Correspondence Address: MICHAEL BEST & FRIEDRICH LLP, 100 E WISCONSIN AVENUE, Suite 3300, MILWAUKEE, WI, 53202, US

(73) Assignee: HARLEY-DAVIDSON MOTOR COMPANY GROUP, INC., Milwaukee, WI (US)

(21) Appl. No.: 11/933,588

(22) Filed: Nov. 1, 2007

(51) Int. Cl. B62J 1/28

(52) U.S. Cl. 297/215.12; 280/63

(57) ABSTRACT

An adjustable backrest assembly includes a backrest and a first frame member coupled to the backrest. The adjustable backrest assembly also includes a second frame member configured to be coupled with a motorcycle. The first frame member is slidable relative to the second frame member along an adjustment axis. The adjustable backrest assembly further includes an actuator movable in the direction of the adjustment axis or about the adjustment axis to selectively allow adjustment of the backrest relative to the second frame member along the adjustment axis.

### FIELD OF THE INVENTION

The present invention relates to motorcycles, and more particularly to motorcycle backrests.

### BACKGROUND OF THE INVENTION

Motorcycle backrests or “sissy bars” are typically used to provide support for the back of a motorcycle passenger while riding. Sissy bars are typically mounted to a motorcycle's fender strut, and include mounting structure to which a backrest pad is attached.

### SUMMARY OF THE INVENTION

The present invention provides, in one aspect, an adjustable backrest assembly adapted for use with a motorcycle. The adjustable backrest assembly includes a backrest and a first frame member coupled to the backrest. The adjustable backrest assembly also includes a second frame member configured to be coupled with the motorcycle. The first frame member is slidable relative to the second frame member along an adjustment axis. The adjustable backrest assembly further includes an actuator movable in the direction of the adjustment axis or about the adjustment axis to selectively allow adjustment of the backrest relative to the second frame member along the adjustment axis.

The present invention provides, in another aspect, a motorcycle including a front wheel, a rear wheel, a frame supported by the front and rear wheels, a backrest, and a first frame member coupled to the backrest. The motorcycle also includes a second frame member coupled to the frame. The first frame member is slidable relative to the second frame member along an adjustment axis. The motorcycle further includes an actuator movable in the direction of the adjustment axis or about the adjustment axis to selectively allow adjustment of the backrest relative to the second frame member along the adjustment axis.

Other features and aspects of the invention will become apparent by consideration of the following detailed description and accompanying drawings.

### BRIEF DESCRIPTION OF THE DRAWINGS

FIG. 1 is a front perspective view of a motorcycle incorporating a first construction of an adjustable backrest assembly embodying the present invention.

FIG. 2 is an exploded, reverse perspective view of the adjustable backrest assembly shown in FIG. 1.

FIG. 3 is an enlarged side view of the adjustable backrest assembly shown in FIG. 1.

FIG. 4 is a rear view of the adjustable backrest assembly along viewing plane 4-4 in FIG. 3.

FIG. 5 is a cross-sectional view taken along line 5-5 in FIG. 4, illustrating an actuator in a locked position.

FIG. 6 is a cross-sectional view similar to FIG. 5, illustrating the actuator in an unlocked position.

FIG. 7 is a front perspective view of a motorcycle incorporating a second construction of an adjustable backrest assembly embodying the present invention.

FIG. 8 is an exploded, reverse perspective view of the adjustable backrest assembly shown in FIG. 7.

FIG. 9 is an enlarged side view of the adjustable backrest assembly shown in FIG. 7.

FIG. 10 is a rear view of the adjustable backrest assembly along viewing plane 10-10 in FIG. 9.

FIG. 11 is a cross-sectional view, taken along line 11-11 in FIG. 10, illustrating an actuator in a locked position.

FIG. 12 is a cross-sectional view similar to FIG. 11, illustrating the actuator in an unlocked position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

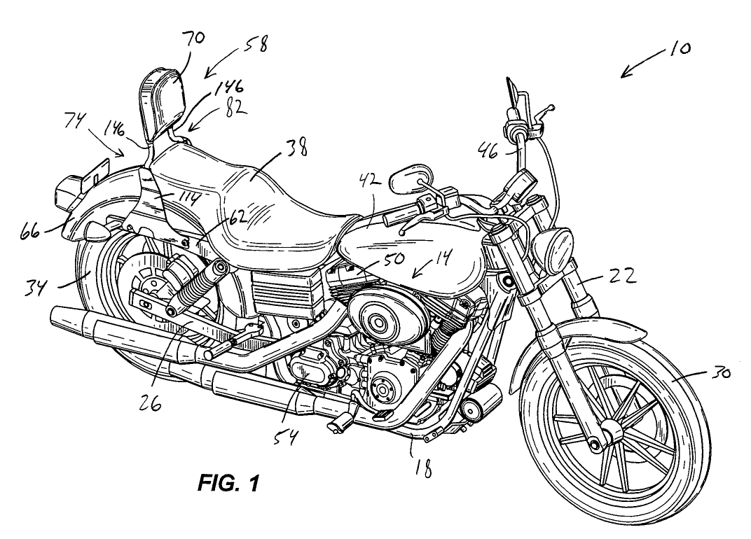

FIG. 1 illustrates a motorcycle 10 including a drive assembly 14, a frame 18, a front fork assembly 22, a swing arm or rear fork assembly 26, a front wheel 30, a rear wheel 34, a seat 38, and a fuel tank 42. The frame 18 supports the drive assembly 14, the front fork assembly 22, the rear fork assembly 26, the seat 38, and the fuel tank 42. The front fork assembly 22 is pivotally supported at a front end of the motorcycle 10 and supports the front wheel 30. The front fork assembly 22 includes a pair of handle bars 46 for steering the motorcycle 10. The rear fork assembly 26 is coupled to the frame 18 at a rear end of the motorcycle 10 and rotatably supports the rear wheel 34. The seat 38 is coupled to the frame 18 and is configured for supporting a rider. The fuel tank 42 is supported by the frame 18 and provides fuel to the drive assembly 14.

The drive assembly 14 is coupled to the frame 18 beneath the seat 38 between the front wheel 30 and the rear wheel 34 of the motorcycle 10. With continued reference to FIG. 1, the drive assembly 14 includes an engine 50 and a transmission 54. The engine 50 is a V-twin engine and includes an output shaft (not shown), such as a crankshaft, which includes a primary drive sprocket (not shown) for driving a primary chain (not shown) in a conventional manner to power the transmission 54.

FIG. 1 also illustrates an adjustable backrest assembly 58 coupled to the motorcycle 10. The adjustable backrest assembly 58 is coupled to the motorcycle 10 via fender struts 62 (only one of which is shown) located on opposite sides of a rear fender 66 of the motorcycle 10. The fender struts 62 are directly mounted to the frame 18, such that the adjustable backrest assembly 58 is rigidly supported by the frame 18. However, any of a number of different structures besides the fender struts 62 may be utilized to mount the adjustable backrest assembly 58 to the frame 18 of the motorcycle 10.

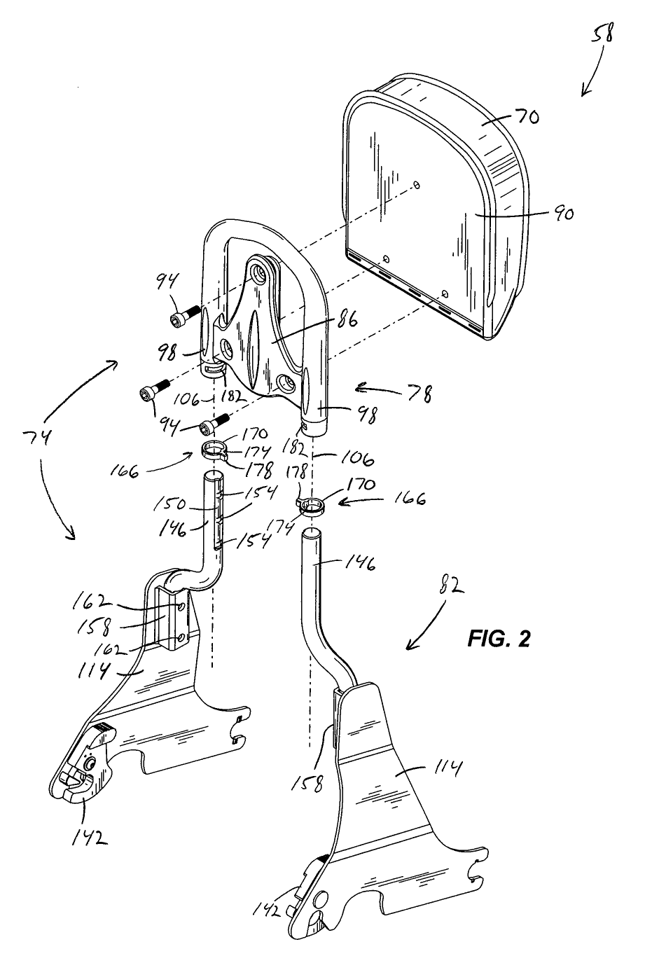

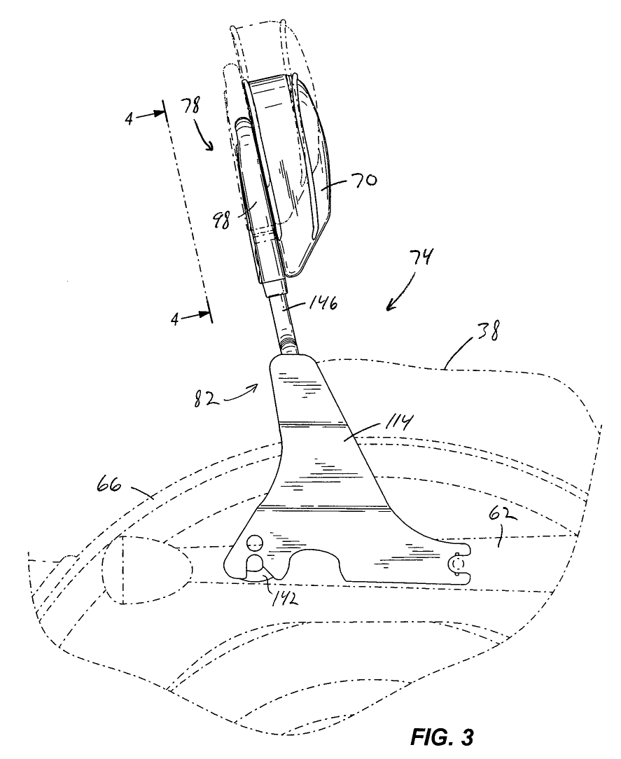

With reference to FIGS. 1 and 2, the adjustable backrest assembly 58 includes a backrest 70 and a frame 74 coupling the backrest 70 to the motorcycle 10. The backrest 70 may include any of a number of different types of padding material therein, and may also be shaped in any of a number of different ways to provide different levels of support for motorcycle passengers or different styles to enhance the overall look of the motorcycle 10. With reference to FIG. 2, the frame 74 includes a first frame member 78 coupled to the backrest 70 and a second frame member 82 coupled to the motorcycle 10. As shown in FIG. 3, the first frame member 78 and backrest 70 are movable with respect to the second frame member 82 to adjust the height of the backrest 70 with respect to the seat 38.

With reference to FIG. 2, the first frame member 78 includes a support member 86 onto which the backrest 70 is mounted. Specifically, the backrest 70 includes a mounting plate 90 having a plurality of threaded inserts (not shown) secured thereto. A plurality of fasteners 94 (e.g., bolts or cap screws) are utilized to mount the backrest 70 to the support member 86 via the threaded inserts in the mounting plate 90. The support member 86 may be made from any of a number of different materials (e.g., steel or another metal alloy) using any of a number of different manufacturing processes. Alternatively, the mounting plate 90 of the backrest 70 and support member 86 may be integrally formed as one piece (e.g., from a metal or plastic material), such that no fasteners are required to couple the backrest 70 and the support member 86.

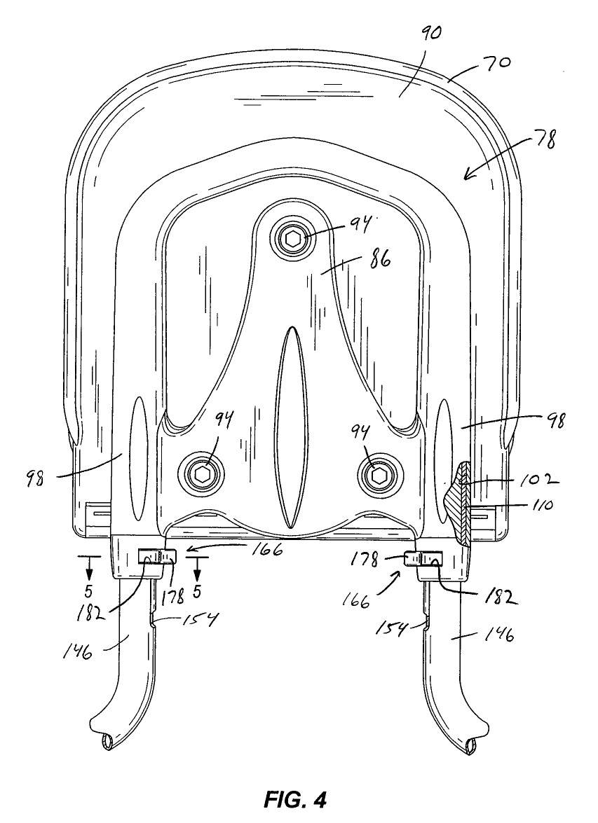

With continued reference to FIG. 2, the first frame member 78 also includes a receiving portion 98 coupled to either side of the support member 86. The receiving portions 98 are integrally formed as a single piece with the support member 86. Alternatively, the support member 86 may be a separate and distinct component from the receiving portions 98, and may be coupled to the receiving portions 98 in any of a number of different manners (e.g., using conventional fasteners, welding, etc.). With reference to FIGS. 2 and 4, each receiving portion 98 includes an aperture 102 defining an adjustment axis 106. A bushing 110 is positioned within each aperture 102 to facilitate the sliding movement or adjustment of the first frame member 78 relative to the second frame member 82. The bushings 110 may be made from any of a number of different materials (e.g., brass, nylon, etc.).

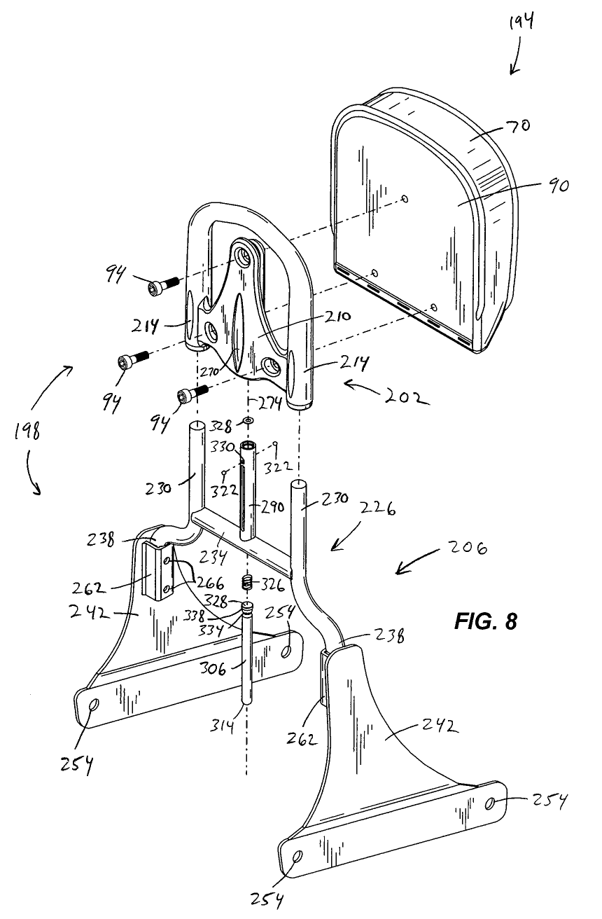

With reference to FIG. 2, the second frame member 82 includes separate brackets 114, each of which is coupled to a respective fender strut 62. Each of the brackets 114 includes a quick-release member 142 to facilitate expeditious mounting and removal of the adjustable backrest assembly 58. The structure and operation of the brackets 114 and quick-release members 142 are described in U.S. Pat. No. 6,443,344, the entire contents of which are incorporated herein by reference. In an alternative construction of the adjustable backrest assembly 58, the brackets 114 may include a plurality of apertures for fastening the brackets 114 to the respective fender struts 62 in a conventional manner (see, for example, the brackets 242 in the adjustable backrest assembly 194 of FIG. 8).

With reference to FIG. 2, the second frame member 82 also includes separate insertion portions 146, each of which is coupled to a respective bracket 114. The insertion portions 146 each include a longitudinal groove 150 and a plurality of laterally-extending grooves 154 opening into the longitudinal groove 150. As explained in more detail below, the laterally-extending grooves 154 provide different adjustment heights for the backrest 70. The laterally-extending grooves 154 are axially spaced from one another along the adjustment axis 106 at regular intervals. Three laterally-extending grooves 154 are formed in each insertion portion 146 to provide three different adjustment heights for the backrest 70. Alternatively, more or fewer than three laterally-extending grooves 154 may be formed in each insertion portion 146 to provide more or fewer than three different adjustment heights for the backrest 70.

With continued reference to FIG. 3, the insertion portions 146 are supported in an inclined orientation with respect to the fender supports 62. Each bracket 114 includes a receptacle 158 sized to snugly receive a lower portion of an insertion portion 146 (see FIG. 2). Fasteners (not shown) are threaded or inserted through apertures 162 in the receptacles to secure the insertion portions 146 to the respective brackets 114. Alternatively, the insertion portions 146 may be secured to the brackets 114 in any of a number of different manners. Further, an alternative construction of the adjustable backrest assembly 58 may include the insertion portions 146 and the brackets 114 integrally formed as a single piece.

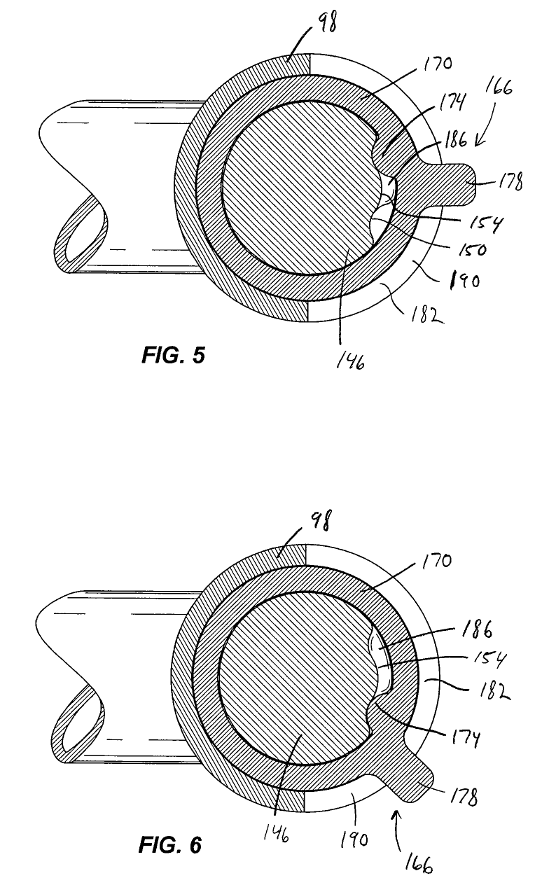

With reference to FIG. 2, the adjustable backrest assembly 58 also includes dual actuators 166 movable about the adjustment axes 106 of the respective receiving portions 98. The actuator 166 is configured as a lock ring 170 having a radially-inward facing protrusion 174 and a radially-outward facing tab 178 (see also FIGS. 5 and 6). A circumferential slot 182 is formed in each receiving portion 98 to receive the lock rings 170. The slot 182 extends about half-way around the circumference (e.g., about 180 degrees) of each receiving portion 98, and the height of the slots 182 is substantially similar to the height or thickness of the lock rings 170. As a result, the lock rings 170 can be coupled to the respective receiving portions 98 by sliding the lock rings 170 through the slots 182 in a direction substantially transverse to the adjustment axes 106 of the respective receiving portions 98, such that the tabs 178 protrude through the slots 182 and extend outwardly of an outer surface of the receiving portions 98. The sliding engagement of the tabs 178 in the respective slots 182 substantially maintains the lock rings 170 in position in the respective receiving portions 98 before engagement with the respective insertion portions 146. With reference to FIGS. 5 and 6, each lock ring 170 includes an outer diameter that is slightly less than the inner diameter of the receiving portion 98, and an inner diameter that is slightly larger than the outer diameter of the insertion portion 146 to provide sufficient clearance to allow the lock rings 170 to freely rotate about the respective adjustment axes 106.

With reference to FIGS. 3 and 4, the backrest 70 is shown in a first position with respect to the second frame member 82 and the seat 38. In this position, the respective protrusions 174 of the lock rings 170 are positioned within the laterally-extending grooves 154 in the respective insertion portions 146 that correspond to the first position of the backrest 70 with respect to the second frame member 82 and the seat 38 (see FIG. 5). As such, the opposed upper and lower surfaces 186 defining the laterally-extending groove 154 (the lower surface 186 being shown in FIGS. 5 and 6) confine the protrusion 174 within the groove 154, preventing movement of the lock ring 170 relative to the insertion portion 146 along the adjustment axis 106. Also, the opposed upper and lower surfaces 190 defining the slot 182 (the lower surface 190 being shown in FIGS. 5 and 6) confine the tab 178 within the slot 182, preventing movement of the receiving portion 98 relative to the lock ring 170 along the adjustment axis 106, thereby locking the first frame member 78 to the second frame member 82.

To unlock the first frame member 78 from the second frame member 82, the protrusions 174 of the respective lock rings 170 are moved out of the laterally-extending grooves 154 of the respective insertion portions 146 and into the longitudinally-extending grooves 150 of the respective insertion portions 146. An operator may accomplish this by grasping the tabs 178 on the respective lock rings 170, and rotating the rings 170 about the respective adjustment axes 106 to the rotational position shown in FIG. 6, where the protrusions 174 of the respective lock rings 170 are aligned with and disposed in the longitudinally-extending grooves 150 of the respective insertion portions 146. The operator may then grasp the backrest 70 or the first frame member 78 and move the backrest 70 to a second position with respect to the second frame member 82 and the seat 38 (shown in phantom in FIG. 3). Subsequently, when the protrusions 174 are aligned with a different pair of laterally-extending grooves 154 in the respective insertion portions 146, the lock rings 170 may again be rotated about their respective adjustment axes 106 to position the protrusions 174 in the respective laterally-extending grooves 154 to lock the backrest 70 and first frame member 78 to the second frame member 82.

An alternative construction of the adjustable backrest assembly, however, might include the insertion portions 146 being formed with or coupled to the support member 86, and the receiving portions 98 being formed with or coupled to the respective brackets 114. Further, alternative constructions of the adjustable backrest assembly may include the lock ring 170 on only a single side of the respective first and second frame members 78, 82.

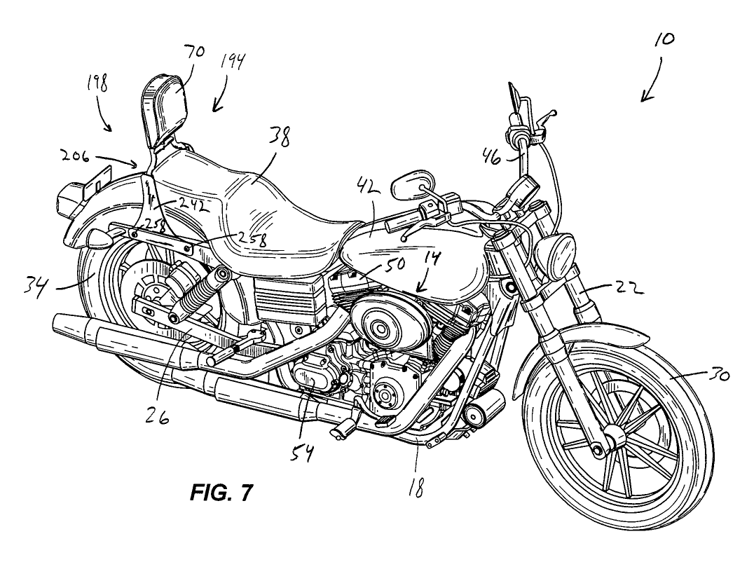

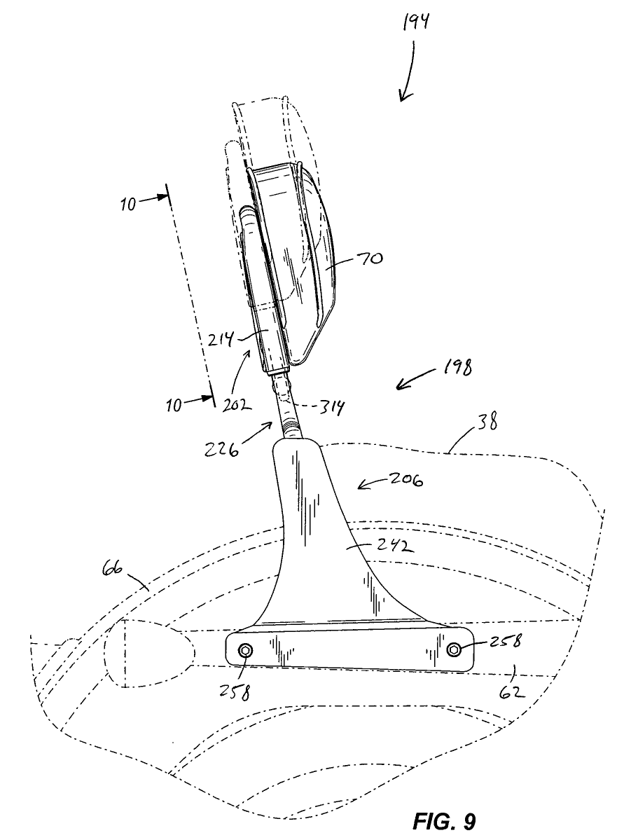

FIGS. 7-12 illustrate a second construction of an adjustable backrest assembly 194 coupled to a motorcycle 10. Like components are labeled with like reference numerals. With reference to FIG. 8, the adjustable backrest assembly 194 includes a backrest 70 and a frame 198 coupling the backrest 70 to the motorcycle 10. The backrest 70 is substantially similar to the backrest 70 shown in FIGS. 1-4, and will not be described again in detail. With reference to FIG. 8, the frame 198 includes a first frame member 202 coupled to the backrest 70 and a second frame member 206 coupled to the motorcycle 10. As shown in FIG. 9, the first frame member 202 and backrest 70 are movable with respect to the second frame member 206 to adjust the height of the backrest 70 with respect to the seat 38.

With reference to FIG. 8, the first frame member 202 includes a support member 210 onto which the backrest 70 is mounted. The backrest 70 may be coupled to the support member 210 in the same manner as the backrest 70 and support member 86 of the adjustable backrest assembly 58 of FIGS. 1-6.

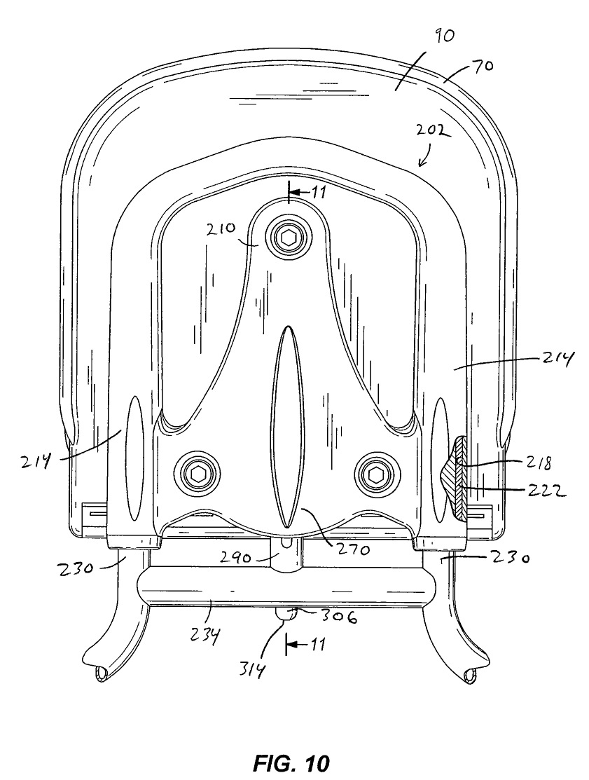

With reference to FIGS. 8 and 10, the first frame member 202 also includes first and second receiving portions 214 defining respective apertures 218 therein. Bushings 222 are positioned within the respective apertures 218 to facilitate the sliding movement or adjustment of the first frame member 202 relative to the second frame member 206. The bushings 222 may be made from any of a number of different materials (e.g., brass, nylon, etc.).

With reference to FIG. 8, the second frame member 206 includes a substantially “H-shaped” member 226, including a pair of substantially parallel upright members 230, a transverse member 234 connecting the two upright members 230, and a pair of mounting members 238 contiguous with the respective upright members 230. Also, the mounting members 238 are substantially parallel with the respective upright members 230 and offset from the respective upright members 230. The illustrated H-shaped member 226 may be made in any of a number of different ways. For example, the upright and mounting members 230, 238 may each be formed from a single piece of steel tubing using a tube-bending process, and the transverse member 234 may be welded to the two pieces of tubing to interconnect them. Alternatively, other materials besides steel may be utilized in making the H-shaped member 226.

The second frame member 206 also includes separate brackets 242 that connect the H-shaped member 226 to the fender struts 62. Each of the brackets 242 includes a plurality of apertures 254 through which fasteners 258 (e.g., bolts) are utilized to secure the brackets 242 to the fender struts 62 (see FIG. 7). Alternatively, the brackets 242 may be configured similarly to the brackets 114 of the adjustable backrest assembly 58 of FIGS. 1-6.

With reference to FIG. 9, the H-shaped member 226 is supported in an inclined orientation with respect to the fender struts 62. The brackets 242 include respective receptacles 262 sized to snugly receive the mounting members 238 (see FIG. 8). Fasteners (not shown) are threaded or inserted through apertures 266 in the receptacle 262 to secure the mounting members 238 to the respective brackets 242. Alternatively, the mounting members 238 may be secured to the brackets 242 in any of a number of different manners. Further, an alternative construction of the adjustable backrest assembly may include the H-shaped member 226 and the brackets 242 integrally formed as a single piece.

Taken in combination, each set of engaged upright members 230 and receiving portions 214 comprises a telescoping member configured to couple the backrest 70 to the motorcycle 10 and guide the backrest 70 as it is adjusted with respect to the seat 38. An alternative construction of the adjustable backrest assembly, however, might include the upright members 230 being formed as portions of the first frame member 202, and the receiving portions 214 being formed as portions of the second frame member 206.

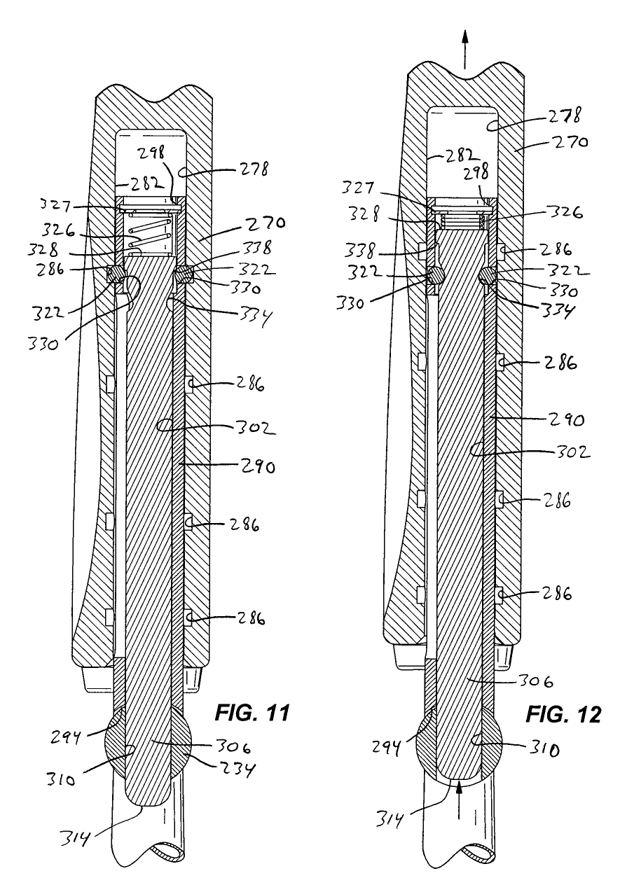

With continued reference to FIGS. 8 and 10-12, the first frame member 202 also includes a third receiving portion 270 defining an adjustment axis 274. The receiving portion 270 is formed as a portion of the support member 210, and defines an aperture 278 therein. A peripheral surface 282 of the aperture 278 includes at least two, and in the illustrated construction four, circumferential grooves 286 formed therein, the purpose of which is discussed below. As shown in FIGS. 11 and 12, the grooves 286 are axially spaced from one another along the adjustment axis 274 at regular intervals. However, alternative constructions of the adjustable backrest assembly might include the receiving portion 270 having grooves 286 spaced from each another at irregular intervals.

With reference to FIG. 8, the second frame member 206 also includes an insertion portion 290 coupled to the transverse member 234 of the H-shaped member 226 and is oriented substantially parallel with the upright members 230. The insertion portion 290 includes a round tube having a lower end 294 and an upper end 298. As shown in FIGS. 8, 11, and 12, the lower end 294 of the tube may be secured to the transverse member 234 by any of a number of different processes (e.g., by welding, soldering, etc.). Alternative constructions of the adjustable backrest assembly might include, however, a one-piece integrally formed (e.g., from a metal or plastic material) H-shaped member 226 including the insertion portion 290.

With continued reference to FIGS. 11 and 12, the insertion portion 290 defines an aperture 302 therein to slidably receive an actuator 306. The actuator 306 is also configured with a round cross-section and is sized to snugly fit within the aperture 302 in the insertion portion 290 such that the actuator 306 is movable relative to the insertion portion 290 along the adjustment axis 274. The transverse member 234 includes an aperture 310 substantially aligned with the aperture 302 in the insertion portion 290, so that the actuator 306 may be slidably inserted through the aperture 310 and received within the aperture 302 of the insertion portion 290. As shown in FIGS. 11 and 12, a lower portion of the actuator 306, including a lower end surface 314, extends through the aperture 310 in the transverse member 234 and is accessible beneath the transverse member 234. However, alternative constructions of the adjustable backrest assembly might include a split transverse member, such that the lower end 294 of the insertion portion 290 is accessible without necessitating the pass-through aperture 310 in the transverse member 234.

With reference to FIGS. 8, 11, and 12, the adjustable backrest assembly 194 also includes a detent mechanism operably engaged by the actuator 306. The detent mechanism includes at least one, and in the illustrated construction two, detent members in the form of spherical balls 322 that are biased radially outwardly from the adjustment axis 274 by a compression spring 326. As shown in FIGS. 11 and 12, the compression spring 326 is positioned between a retainer 327 positioned in the upper end 298 of the insertion portion 290 and an upper end surface 328 of the actuator 306, such that the compression spring 326 downwardly biases the actuator 306 relative to the orientation shown in FIGS. 11 and 12.

The insertion portion 290 includes at least one aperture 330, and in the illustrated construction two apertures 330, in which the respective spherical balls 322 are supported. The actuator 306 also includes a circumferential groove 334 formed therein near the upper end surface 328 of the actuator 306. The groove 334 is sized to receive at least a portion of the spherical balls 322 when the actuator 306 is moved, against the bias of the compression spring 326, to align the groove 334 with the apertures 330 in the insertion portion 290. Also, a stepped portion 338 of the actuator 306 between the groove 334 and the upper end surface 328 biases the spherical balls 322 radially outwardly when the compression spring 326 urges the actuator 306 downwardly (relative to the orientation shown in FIGS. 11 and 12) to misalign the groove 334 and the apertures 330 in the insertion portion 290. It should be noted that alternative constructions of the adjustable backrest assembly might include a reverse orientation of the components illustrated in FIGS. 1 and 12—i.e., the receiving portion 270 may be formed on the H-shaped member 226, and the insertion portion 290 may be formed or coupled to the backrest 70 and/or the support member 210. In such an alternative construction of the adjustable backrest assembly, the actuator 306 would be upwardly biased by the compression spring 326.

Should a motorcycle passenger desire to adjust the position of the backrest 70 relative to the seat 38 of the motorcycle 10 from a first position (see FIG. 9) to a second position along the adjustment axis 274, the passenger would depress the actuator 306 against the bias of the compression spring 326, thereby causing the groove 334 in the actuator 306 to substantially align with the apertures 330 in the insertion portion 290. Once the groove 334 and the apertures 330 are substantially aligned, the spherical balls 322 are allowed to at least partially “fall into” the groove 334 such that the spherical balls 322 are substantially removed from the particular groove 286 in the receiving portion 270 that correlates with the first position of the backrest 70 (see FIG. 12). Once the spherical balls 322 are disengaged or removed from the groove 286 in the receiving portion 270, the backrest 70 may be freely adjusted along the adjustment axis 274 relative to the seat 38.

Before the backrest 70 reaches the second position, but after the backrest 70 has passed through any intermediate, pre-defined position by other grooves 286 in the receiving portion 270, the passenger may release the actuator 306, thereby allowing the compression spring 326 to downwardly urge the actuator 306 and, in turn, urge the spherical balls 322 radially outwardly from the adjustment axis 274. When the spherical balls 322 align with the particular groove 286 in the receiving portion 270 that correlates with the second position of the backrest 70, the spherical balls 322 are further urged radially outwardly by the compression spring 326 and the stepped portion 338 of the actuator 306 to cause the spherical balls 322 to engage or be received in the particular groove 286 associated with the second position. The same steps may be utilized to adjust the backrest 70 to any of the positions associated with the spaced grooves 286 in the receiving portion 270.

Various features of the invention are set forth in the following claims.

What is claimed is:

1. An adjustable backrest assembly configured for use with a motorcycle, the adjustable backrest assembly comprising:
a backrest;
a first frame member coupled to the backrest;
a second frame member configured to be coupled with the motorcycle, the first frame member slidable relative to the second frame member along an adjustment axis; and
an actuator movable in at least one of the direction of the adjustment axis and about the adjustment axis to selectively allow adjustment of the backrest relative to the second frame member along the adjustment axis.

2. The adjustable backrest assembly of claim 1, wherein the first frame member includes one of a receiving portion defining the adjustment axis, and an insertion portion slidably engageable with the receiving portion along the adjustment axis, and wherein the second frame member includes the other of the receiving portion and the insertion portion.

3. The adjustable backrest assembly of claim 2, wherein the actuator is movable about the adjustment axis to selectively allow adjustment of the backrest relative to the second frame member along the adjustment axis, wherein the insertion portion includes one of a protrusion and a groove, wherein the actuator includes the other of the protrusion and the groove, and wherein the protrusion is positioned within the groove to lock the backrest relative to the second frame member.

4. The adjustable backrest assembly of claim 3, wherein the actuator is configured as a ring rotatably supported on the receiving portion about the adjustment axis, and wherein the insertion portion is inserted through the ring.

5. The adjustable backrest assembly of claim 3, wherein the insertion portion includes the groove, wherein the groove is a first groove, wherein the insertion portion includes a second groove spaced from the first groove along the adjustment axis, wherein the protrusion is positioned within the first groove to secure the backrest relative to the second frame member in a first position, and wherein the protrusion is positioned within the second groove to secure the backrest relative to the second frame member in a second position.

6. The adjustable backrest assembly of claim 5, wherein the first groove and the second groove extend substantially laterally on the insertion portion, and wherein the insertion portion includes a longitudinal groove connecting the first groove and the second groove.

7. The adjustable backrest assembly of claim 6, wherein the actuator is configured as a ring rotatably supported on the receiving portion about the adjustment axis, and wherein the protrusion is coupled to an interior surface of the ring.

8. The adjustable backrest assembly of claim 7, wherein the ring is rotatable about the adjustment axis between a first rotational position, in which the protrusion is positioned within one of the first groove and the second groove, and a second rotational position, in which the protrusion is positioned in the longitudinal groove.

9. The adjustable backrest assembly of claim 7, wherein the actuator includes a tab extending outwardly from an outer surface of the first frame member relative to the adjustment axis.

10. The adjustable backrest assembly of claim 1, wherein the first frame member includes one of a receiving portion defining the adjustment axis, and an insertion portion slidably engageable with the receiving portion along the adjustment axis, wherein the second frame member includes the other of the receiving portion and the insertion portion, wherein the actuator is movable in the direction of the adjustment axis, and wherein the adjustable backrest assembly further includes a detent mechanism operably engaged by the actuator to selectively allow adjustment of the backrest relative to the second frame member.

11. The adjustable backrest assembly of claim 10, wherein the receiving portion includes a first groove and a second groove spaced from the first groove along the adjustment axis, wherein the detent mechanism engages the first groove in a first position of the backrest relative to the second frame member, and wherein the detent mechanism engages the second groove in a second position of the backrest relative to the second frame member.

12. The adjustable backrest assembly of claim 10, wherein the detent mechanism includes
at least one detent member at least partially positioned within the insertion portion; and
a spring biasing the at least one detent member radially outwardly from the insertion portion.

13. The adjustable backrest assembly of claim 1, wherein the actuator is movable in the direction of the adjustment axis, wherein the adjustable backrest assembly further includes at least two telescoping members interconnecting the first frame member and the second frame member, and wherein each of the telescoping members is adjustable in the direction of the adjustment axis.

14. A motorcycle comprising:
a front wheel;
a rear wheel;
a frame supported by the front and rear wheels;
a backrest;
a first frame member coupled to the backrest;
a second frame member coupled to the frame, the first frame member slidable relative to the second frame member along an adjustment axis; and
an actuator movable in at least one of the direction of the adjustment axis and about the adjustment axis to selectively allow adjustment of the backrest relative to the second frame member along the adjustment axis.

15. The motorcycle of claim 14, wherein the first frame member includes one of a receiving portion defining the adjustment axis and an insertion portion slidably engageable with the receiving portion along the adjustment axis, and wherein the second frame member includes the other of the receiving portion and the insertion portion.

16. The motorcycle of claim 15, wherein the actuator is movable about the adjustment axis to selectively allow adjustment of the backrest relative to the second frame member along the adjustment axis, wherein the insertion portion includes one of a protrusion and a groove, wherein the actuator includes the other of the protrusion and the groove, and wherein the protrusion is positioned within the groove to lock the backrest relative to the second frame member.

17. The motorcycle of claim 16, wherein the insertion portion includes the groove, wherein the groove is a first groove, wherein the insertion portion includes a second groove spaced from the first groove along the adjustment axis, wherein the protrusion is positioned within the first groove to secure the backrest relative to the second frame member in a first position, and wherein the protrusion is positioned within the second groove to secure the backrest relative to the second frame member in a second position.

18. The motorcycle of claim 17, wherein the first groove and the second groove extend substantially laterally on the insertion portion, and wherein the insertion portion includes a longitudinal groove connecting the first groove and the second groove.

19. The motorcycle of claim 18, wherein the actuator is configured as a ring rotatably supported on the receiving portion about the adjustment axis, and wherein the protrusion is coupled to an interior surface of the ring.

20. The motorcycle of claim 19, wherein the ring is rotatable about the adjustment axis between a first rotational position, in which the protrusion is positioned within one of the first groove and the second groove, and a second rotational position, in which the protrusion is positioned in the longitudinal groove.

21. The motorcycle of claim 19, wherein the actuator includes a tab extending outwardly from an outer surface of the first frame member relative to the adjustment axis.

22. The motorcycle of claim 14, wherein the actuator is movable in the direction of the adjustment axis, and wherein the motorcycle further includes a detent mechanism operably engaged by the actuator to selectively allow adjustment of the backrest relative to the second frame member.
